(19) United States
(12) Patent Application Publication
(10) Pub. No.: US 2012/0163117 A1
(43) Pub. Date: Jun. 28, 2012

(54) MIXING APPARATUS

(76) Inventors: Linton Joseph Guidry, JR., Larose, LA (US); Jessica Ashley Crosier, Larose, LA (US); Donald Anthony Hebert, Larose, LA (US)

(21) Appl. No.: 12/978,137

(22) Filed: Dec. 23, 2010

(51) Int. Cl. B01F 11/00

(52) U.S. Cl. 366/214

(57) ABSTRACT

An apparatus and a method for mixing a substance such as tattoo ink or nail polish may comprise a rotor rotatable about a fixed axis, one or more holders on the rotor for receiving a container containing the substance and disposing the container perpendicular to the fixed axis, and a motor for applying a force to rotate the rotor around the fixed axis at less than about 120 revolutions per minute (RPM). The method may comprise receiving a container containing the substance into one or more holders on a rotor, in which the rotor is rotatable about a fixed axis, and applying a force to rotate the rotor about the fixed axis at less than about 120 RPM.

### BACKGROUND OF THE INVENTION

The present invention generally relates to an apparatus, and more particularly relates to an apparatus for mixing substances.

Currently, tattoo ink and nail polish need to be shaken so that they are mixed before they may be used to ink a tattoo or to paint a nail. Generally, a tattoo artist or a manicurist may manually shake a bottle of tattoo ink or nail polish to satisfactorily mix those substances.

However, not only is the task of shaking the bottles time consuming and monotonous, it means that the tattoo artist or manicurist does not have a free hand to perform other tasks, thereby prolonging the process of preparing to ink a tattoo or to perform a manicure.

As can be seen, there is a need for a way to free tattoo artists and manicurists from having to manually shake and mix tattoo ink and nail polish.

### SUMMARY OF THE INVENTION

In one aspect of the present invention, an apparatus for mixing a substance comprises a rotor rotatable about a fixed axis; one or more holders on the rotor for receiving and disposing a container containing the substance, the container disposed perpendicular to the fixed axis; and a motor for applying a force to rotate the rotor around the fixed axis at less than about 120 revolutions per minute (RPM).

In another aspect of the present invention, a method for mixing a substance comprises receiving a container containing the substance into one or more holders on a rotor, wherein the rotor is rotatable about a fixed axis; and applying a force to rotate the rotor about the fixed axis at less than about 120 RPM.

These and other features, aspects and advantages of the present invention will become better understood with reference to the following drawings, description and claims.

### BRIEF DESCRIPTION OF THE DRAWINGS

FIG. 1 shows a perspective view of a mixing apparatus in use in accordance with an embodiment of the present invention;

FIG. 2 shows a section view of the mixing apparatus of FIG. 1 taken along line 2-2 in FIG. 1; and

FIG. 3 shows a perspective view of a mixing apparatus in accordance with an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a mixing apparatus for mixing substances such as tattoo ink and nail polish before those substances are used. Containers containing the substances may be placed on the apparatus where the substances may be continually rotated to mix the substances.

By continually mixing substances such as tattoo ink, nail polish, or other substances which may need to be mixed, the mixing apparatus may free a tattoo artist or manicurist from having to physically rotate, shake, or otherwise mix tattoo ink or nail polish. Thus, the tattoo artist or manicurist may be free to perform other tasks in preparation for inking a tattoo or performing a manicure.

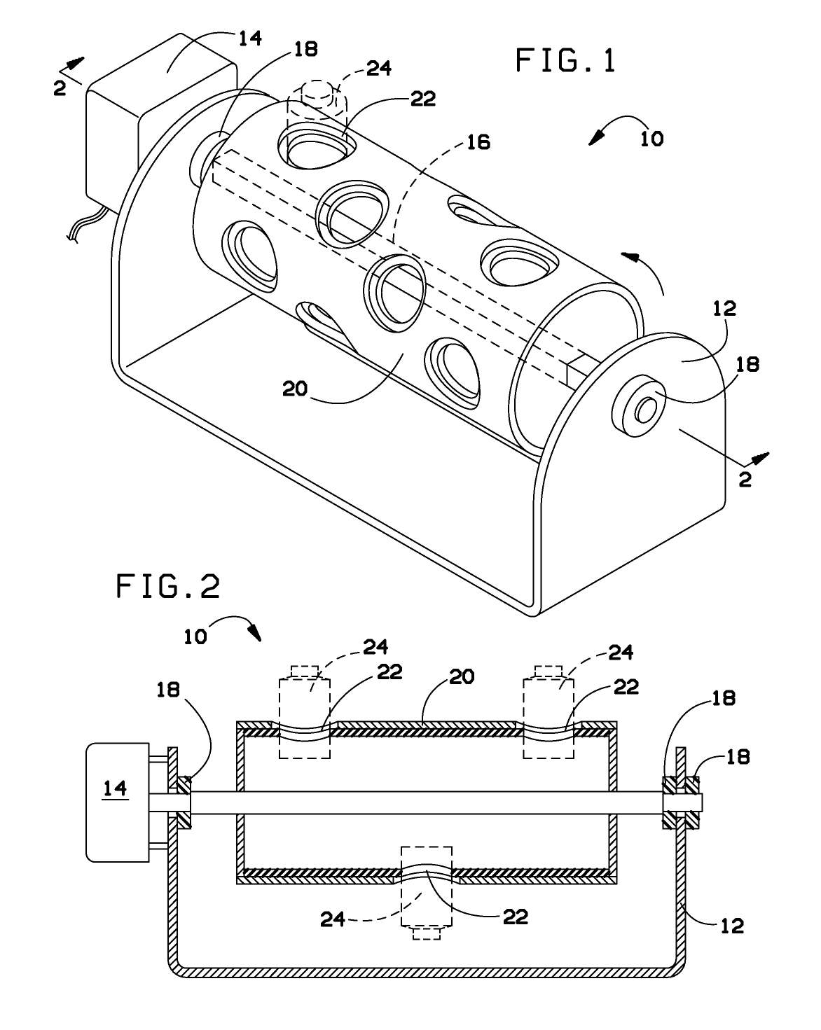

Referring now to FIG. 1 and FIG. 2, a mixing apparatus for mixing a substance may include a rotor, such as a cage 20, that may rotate about a fixed axis. The cage 20 may include holders 22 for holding containers 24 containing the substance to be mixed. As shown in FIG. 1, the cage 20 may be a cage containing openings that may function as the holders 22, so that the holders 22 may receive and secure the containers 24 to the cage 20.

The holders 22 may hold the containers 24 so that they are disposed perpendicularly to the fixed axis about which the cage 20 rotates. During the course of rotating the cage 20, the orientation of the containers 24 may also undergo a 360° change in orientation corresponding with the rotation of the cage 20.

A motor 14 may drive a driveshaft 16 mounted on a frame 12 to rotate the cage 20 operably coupled to the driveshaft 16. The driveshaft 16 may be situated along the fixed axis and may be aided by the bearings 18 to rotate about the fixed axis. The motor 14 may drive the driveshaft 16 by applying a force to the drive shaft to cause the driveshaft 16 and the cage 20 to rotate about the fixed axis. For example, the force applied by the motor 14 may be a force perpendicular to the axis, or may be any other appropriate force to cause the drive shaft 16 and the cage 20 to rotate about the fixed axis.

The motor 14 may drive the driveshaft 16 and the cage 20 at a speed that is sufficient to mix the substances contained within the holders 22 by shaking the substances contained within the holders 22. Unlike centrifuges, where the goal is to separate substances by spinning at a very high speed, the apparatus 10 instead may be used to mix substances. Generally, the motor 14 may drive the driveshaft 16 so that the cage 20 rotates at less than about 120 revolutions per minute (RPM). More specifically, the motor 14 may drive the driveshaft 16 so that the cage 20 rotates at about 60 RPM.

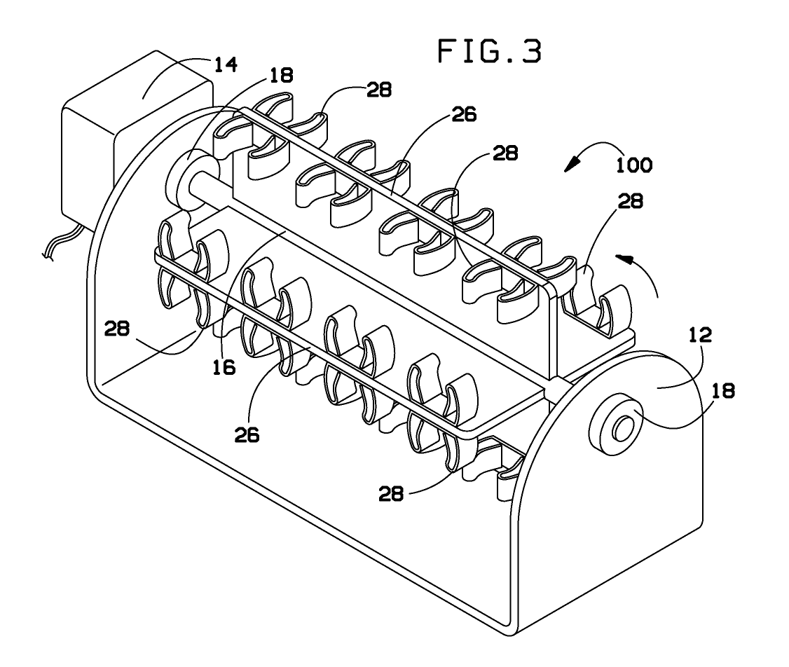

Referring now to FIG. 3, in an alternative embodiment of the present invention, an alternate mixing apparatus 100 may include a rotating holder support 26 as the rotor that may rotate about a fixed axis. The rotating holder support 26 may include holder clamps 28 for clamping containers 24 (not shown) to the rotating holder supper 26 so that the containers 24 are disposed perpendicularly to the fixed axis.

A motor 14 may drive a driveshaft 16 mounted on a frame 12 to rotate the rotating holder support 26 operably coupled to the driveshaft 16. The driveshaft 16 may be situated along the fixed axis and may be aided by the bearings 18 to rotate about the fixed axis. The motor 14 may drive the driveshaft 16 by applying a force to the fixed axis to cause the driveshaft 16 and the rotating holder support 26 to rotate about the fixed axis.

Generally, the motor 14 may drive the driveshaft 16 so that the cage 20 rotates at less than about 120 revolutions per minute (RPM). More specifically, the motor 14 may drive the driveshaft 16 so that the cage 20 rotates at about 60 RPM.

It should be understood, of course, that the foregoing relates to exemplary embodiments of the invention and that modifications may be made without departing from the spirit and scope of the invention as set forth in the following claims.

We claim:

1. An apparatus for mixing a substance, comprising:
a rotor rotatable about a fixed axis;
one or more holders on the rotor for receiving and disposing a container containing the substance, the container disposed perpendicular to the fixed axis; and
a motor for applying a force to rotate the rotor around the fixed axis at less than about 120 revolutions per minute (RPM).

2. The apparatus of claim 1, further comprising:
a driveshaft along the fixed axis that is operably coupled to the rotor, wherein the motor applies the force to the shaft to rotate the driveshaft.

3. The apparatus of claim 2, wherein the one or more holders comprise one or more openings on the rotor.

4. The apparatus of claim 2, wherein the one or more holders comprise one or more clamps operably coupled to the rotor.

5. The apparatus of claim 1, wherein the substance includes tattoo ink.

6. The apparatus of claim 1, wherein the substance includes nail polish.

7. The apparatus of claim 1, wherein the rotor is rotatable around the fixed axis at about 60 RPM.

8. A method for mixing a substance, comprising:
receiving a container containing the substance into one or more holders on a rotor, wherein the rotor is rotatable about a fixed axis; and
applying a force to rotate the rotor about the fixed axis at less than about 120 RPM.

9. The method of claim 8, wherein the substance includes nail polish.

10. The method of claim 8, wherein the substance includes tattoo ink.
